(19) United States
(12) Patent Application Publication
(10) Pub. No.: US 2003/0165309 A1
(43) Pub. Date: Sep. 4, 2003

(54) Compact lightweight optical cable with pad

(76) Inventors: Seung-Hyun Moon, Kumi-shi (KR); Kyung-Tae Park, Kumi-shi (JP)

Correspondence Address: CHA & REITER, 411 HACKENSACK AVE, 9TH FLOOR, HACKENSACK, NJ, 07601, US

(21) Appl. No.: 10/268,192

(22) Filed: Oct. 10, 2002

(30) Foreign Application Priority Data
Mar. 4, 2002 (KR) 2002-11285

(51) Int. Cl. G02B 6/44

(52) U.S. Cl. 385/109; 385/100

(57) ABSTRACT

A small, lightweight optical cable with pads is disclosed. The optical cable comprises a tube having the shape of a hollow cylinder and includes multiple cores of optical fibers mounted therein, a sheath formed by an extrusion method to surround the tube in a certain thickness, and a plurality of pads arranged inside the sheath, each pad being separately formed.

### CLAIM OF PRIORITY

This application makes reference to and claims all benefits accruing under 35 U.S.C. Section 119 from an application entitled, “SMALL, LIGHTWEIGHT OPTICAL CABLE WITH PAD,” filed in the Korean Industrial Property Office on Mar. 4, 2002 and there duly assigned Serial No. 2002-11285.

### BACKGROUND OF THE INVENTION

1. Field of the Invention

The present invention relates to an optical cable and more particularly to a high-density optical cable used in an optical communication field.

2. Description of the Related Art

Currently, there is a high demand for optical cables with high density, small size, and light weight. This demand is due to the fact that a large number of optical cables have already been installed in the existing duct lines; thus, there is a shortage of space for installing new cables. To this end, attempts to reduce the outer diameters of optical cables have been made to increase the packing density of optical fibers in order to make the installation of such cables possible in existing narrow ducts.

FIG. 1 is a sectional view illustrating the configuration of a conventional, small lightweight optical cable. The optical cable comprises multiple cores of optical fibers 110, a tube 120, four cores of strength members 140, and a sheath 130. The tube 120 has the shape of a hollow cylinder and includes multiple cores of the optical fibers 110 mounted therein. The thickness of the tube 120 is approximately 1 mm. The sheath 130 is formed by an extrusion method to surround the tube 120 in a certain thickness. The sheath 130 comprises the outermost layer of the small, lightweight optical cable so as to protect its interior against the external environment. To further enhance the integrity of the cable, four cores of strength members 140 are provided to complement the mechanical weakness of the optical cable to some extent. However, if the external stress is excessive, the strength members 140 tend to deteriorate the mechanical properties of the optical cable.

FIGS. 2 and 3 illustrate the interior of the optical cable when excess stress is applied thereon.

Referring to FIG. 2, the external stress 150 is applied to an outer sheath, which is an outermost layer of the lightweight optical cable. As a result, as shown in FIG. 3, the lightweight optical cable is severely deformed by the applied stress 150. Meanwhile, the strength members 140, which are arranged inside the sheath 130, penetrate into the interior of the sheath and press the tube 120. Note that the tube 120 has a thickness of only approximately 1 mm., but the strength members 140 have a higher degree of hardness than those of the tube 120 or sheath 130, such that the optical fibers 110 mounted inside the tube 120 suffer severe stress due to the strength members 140.

As described above, there is a problem in the conventional lightweight optical cable despite having a plurality of strength members to increase the mechanical strength of the cable. In particular, if external stress is excessive, the strength members tend to deteriorate the mechanical properties of the lightweight optical cable.

### SUMMARY OF THE INVENTION

Therefore, the present invention has been made to overcome the above problems and provides a small, lightweight optical cable capable of minimizing the deterioration of its mechanical properties upon application of the large external stress.

The lightweight optical cable according to the present invention includes a tube having the shape of a hollow cylinder and multiple cores of optical fibers mounted therein; a sheath formed by an extrusion technique to surround the tube in a certain thickness; and, a plurality of pads arranged inside the sheath, each pad being separately formed.

### BRIEF DESCRIPTION OF THE DRAWINGS

The above features and other advantages of the present invention will be more clearly understood from the following detailed description taken in conjunction with the accompanying drawings, in which:

FIG. 1 is a sectional view illustrating the configuration of a conventional, small lightweight optical cable;

FIGS. 2 and 3 are views for explaining the small, lightweight optical cable, illustrated in FIG. 1, upon application of excessive stress;

FIG. 4 is a view illustrating the configuration of a small, lightweight optical cable with pads in accordance with a preferred embodiment of the present invention; and,

FIG. 5 is a view illustrating the configuration of a small, lightweight optical cable with pads in accordance with a preferred alternative embodiment of the present invention.

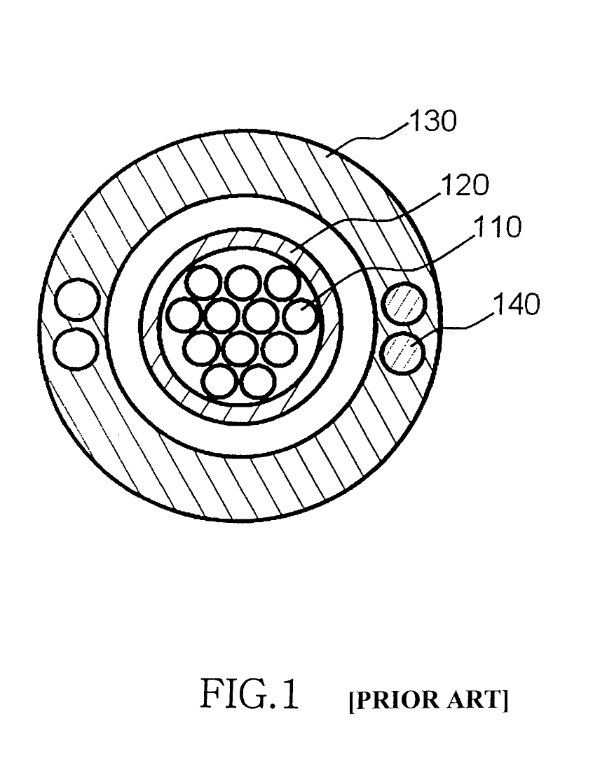

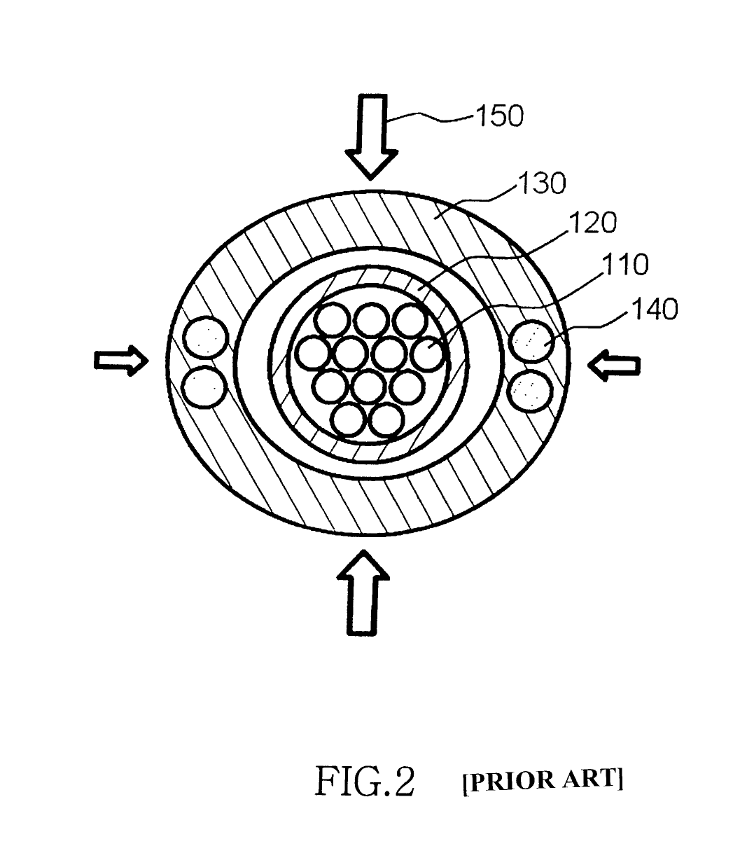

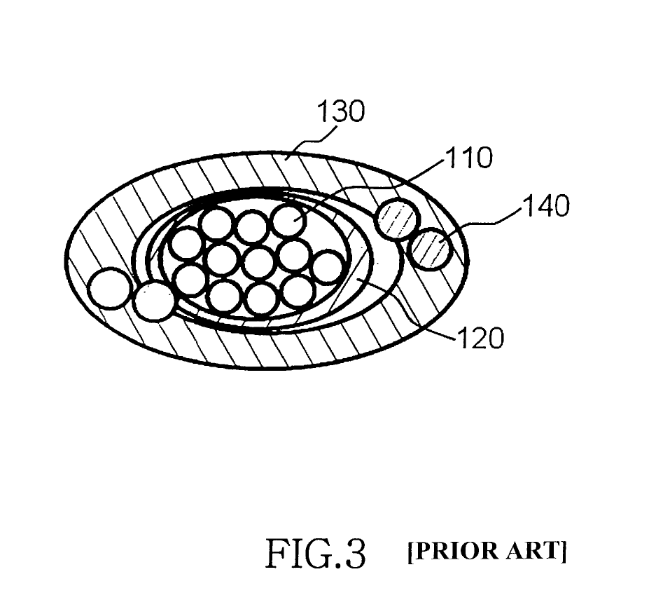

### DESCRIPTION OF THE PREFERRED EMBODIMENTS

Now, preferred embodiments of the present invention will be described in detail with reference to the annexed drawings. For the purposes of clarity and simplicity, a detailed description of known functions and configurations incorporated herein will be omitted to make the subject matter of the present invention clear.

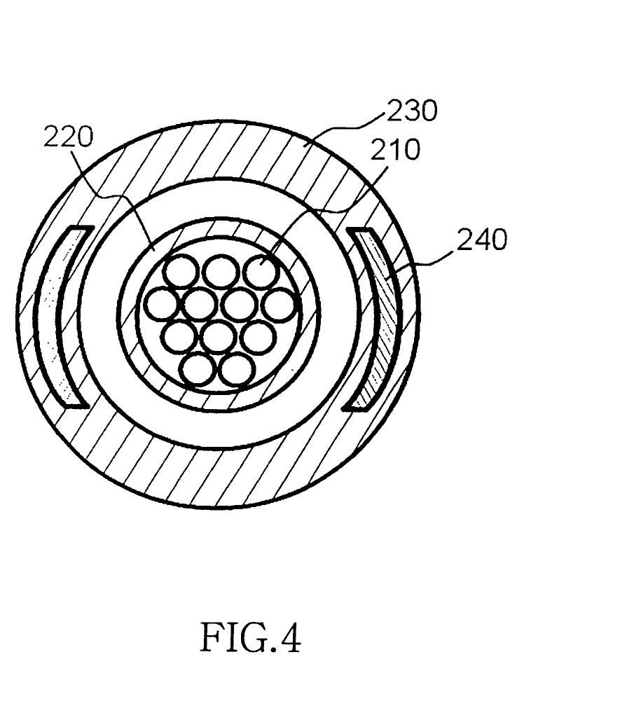

FIG. 4 is a view illustrating the configuration of a small, lightweight optical cable with pads in accordance with a preferred embodiment of the present invention. The inventive optical cable comprises a tube 220, a sheath 230, and a pair of pads 240. The tube 220 has the shape of a hollow cylinder and includes the multiple cores of optical fibers 210 mounted therein. The tube 120 has a thickness of approximately 1 mm. The sheath 230 is formed by an extrusion method to surround the tube 220 in a certain thickness. The sheath 230 forms the outermost layer of the optical cable acting to protect its interior against the external environment. As a material for the sheath 230, polyvinyl chloride (PVC) or polyethylene (PE) is available.

The two pads 240 are arranged inside the sheath 230 symmetrically around the tube 220. Each of the pads 240 is originally substantially flat, but it is bent when configured to form as a part of the optical cable. As a result, the pads become crescent-shaped in cross-section. The pads 240 serve to enhance the mechanical properties of the optical cable. As a material for the pads 240, fiberglass reinforced plastic (FRP) is available. As a result, even upon the application of heavy external stress to the optical cable, the pads 240 stand ready to enclose the tubes 220, without penetrating into the interior of the sheath 230. For forming the sheath 230, dual extrusion and successive extrusion processes are available.

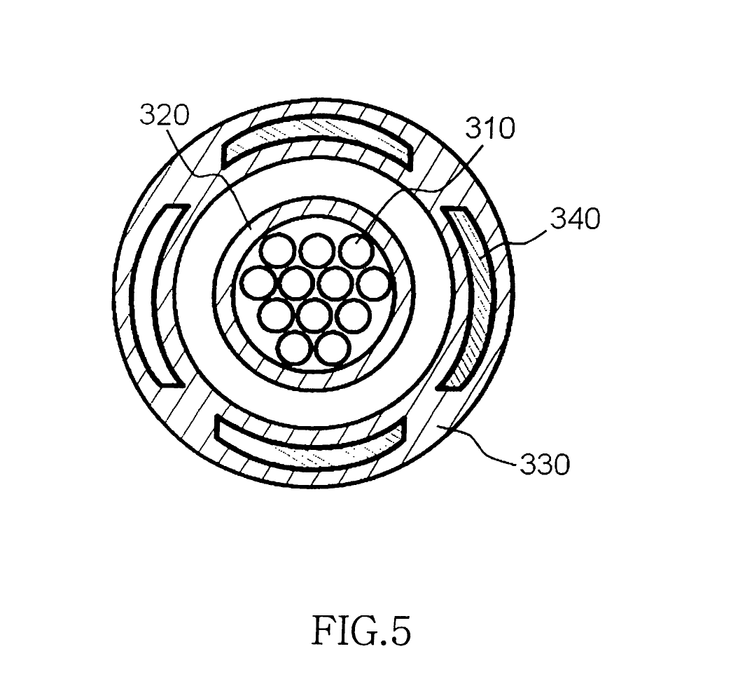

FIG. 5 is a view illustrating the configuration of a small, lightweight optical cable with pads in accordance with another preferred alternative embodiment of the present invention. The inventive optical cable comprises a tube 320, a sheath 330, and four pads 340. The tube 320 has the shape of a hollow cylinder and includes the multiple cores of optical fibers 310 mounted therein. The tube 120 has a thickness of approximately 1 mm. The sheath 330 is formed by extrusion to surround the tube 320 in a certain thickness. The sheath 330 forms the outermost layer of the optical cable to protect its interior against the external environment. As a material for the sheath 330, polyvinyl chloride (PVC) or polyethylene (PE) is available.

Four pads 340 are arranged inside the sheath 330 symmetrically around the tube 220. Each of the pads 340 is originally substantially flat but bent upon formation as a part of the optical cable. As a result, the pads 340 become crescent-shaped in cross-section. The pads 340 perform the function of enhancing mechanical properties of the optical cable. As a material for the pads 340, fiberglass reinforced plastic (FRP) is available. Accordingly, even upon application of an excessive external stress to the optical cable, the structure of the pads 340 allows the pads to enclose the tubes 320 without penetrating into the interior of the sheath 230. For forming the sheath 330, dual extrusion and successive extrusion processes are available.

As apparent from the above description, the small, lightweight optical cable according to the present invention comprises a plurality of pads arranged inside the sheath. This arrangement has the advantage of efficiently protecting optical fibers inside the tube by ensuring that the pads stand ready to enclose the tubes upon application of excessive external stress to the optical cable.

Although the preferred embodiments of the present invention have been disclosed for illustrative purposes, those skilled in the art will appreciate that various modifications, additions, and substitutions are possible without departing from the scope and spirit of the invention as disclosed in the accompanying claims.

What is claimed is:

1. An optical cable comprising:
a tube having a shape of a hollow cylinder including multiple cores of optical fibers mounted therein;
a sheath formed having a predetermined thickness surrounding the tube; and,
a plurality of pads arranged inside the sheath, each pad being separately formed.

2. The optical cable of claim 1, wherein the sheath is formed by a dual extrusion or successive extrusion process.

3. The optical cable of claim 1, wherein the plurality of pads are arranged symmetrically around the tube.

4. The optical cable of claim 1, wherein the sheath is formed using an extrusion technique.
